(19) United States
(12) Patent Application Publication
(10) Pub. No.: US 2013/0166551 A1
(43) Pub. Date: Jun. 27, 2013

(54) CUBITS

(71) Applicants: Mickey MG Wong, New Westminster (CA); David R. St-Denis, Vancouver (CA); Gwen S. Smith, Vancouver (CA); Boris Kovacevic, Vancouver (CA); Christopher J. Gravely, Nanaimo (CA); Thea M. Goldstorm, Vancouver (CA); Christopher A. Brawn, North Vancouver (CA)

(72) Inventors: Mickey MG Wong, New Westminster (CA); David R. St-Denis, Vancouver (CA); Gwen S. Smith, Vancouver (CA); Boris Kovacevic, Vancouver (CA); Christopher J. Gravely, Nanaimo (CA); Thea M. Goldstorm, Vancouver (CA); Christopher A. Brawn, North Vancouver (CA)

(21) Appl. No.: 13/337,669

(22) Filed: Dec. 27, 2011

(51) Int. Cl. G06F 17/30

(52) U.S. Cl. 707/736; 707/E17.044

(57) ABSTRACT

A system may include display of a result set associated with one or more dimensions and one or more key figures, the result set comprising one or more members of each of the one or more dimensions and one or more values of each of the one or more key figures, reception of a selection of a portion of the result set, the portion associated with a first one or more of the one or more dimensions, a second one or more of the one or more key figures, and one or more rows of the result set, and storage of metadata defining the first one or more dimensions, the second one or more key figures, the one or more rows of the result set, and a condition, a schedule to evaluate the condition, and a notification type associated with the portion.

### FIELD

Some embodiments relate to data analysis. More specifically, some embodiments relate to systems to define portions of a report for further usage.

### BACKGROUND

Enterprise software systems receive, generate and store data related to many aspects of a business enterprise. Due to the volume of data, the variety of data, and the speed with which the data accumulates, intermediate systems are required to facilitate users' access to and understanding of the data.

These systems may provide reporting, planning, alerting and/or analysis of underlying data. In one example, a user performs some ad-hoc analysis exploring sales per month for a particular sales region. A system receives the request, queries a data source for the data required by the report, receives the data from the data source, generates the report including the data, and returns the report to the user. Such a system may also or alternatively provide planning functions, such as the generation of a fully or partially-populated sales plan based on underlying data. Additional functions may also be provided, such as complex analysis, graphical presentation and/or the creation of alerts based on the data.

The above-described functions might not be intuitive to a typical business user. Accordingly, the user may be limited to basic functions provided by such intermediate systems, such as a view of a full result set within a standard report. Systems are therefore desired to facilitate the selection of a portion of a result set, and to facilitate further usage of the portion.

### BRIEF DESCRIPTION OF THE DRAWINGS

FIG. 1 is a block diagram of a system according to some embodiments.

FIG. 2 is a flow diagram of a process according to some embodiments.

FIG. 3 is a view of a user interface according to some embodiments.

FIG. 4 is a view of a user interface according to some embodiments.

FIG. 5 is a view of a user interface according to some embodiments.

FIG. 6 is a view of a user interface according to some embodiments.

FIG. 7 is a view of a user interface according to some embodiments.

FIG. 8 is a view of a user interface according to some embodiments.

FIG. 9 is a view of a user interface according to some embodiments.

FIG. 10 is a flow diagram of a process according to some embodiments.

FIGS. 11A through 11C illustrate notifications according to some embodiments.

FIG. 12 is a block diagram of a computing device according to some embodiments.

### DETAILED DESCRIPTION

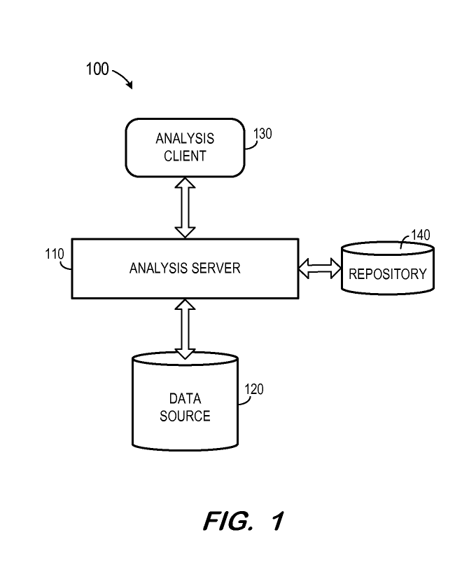

FIG. 1 is a block diagram of system 100 according to some embodiments. FIG. 1 represents a logical architecture for describing processes according to some embodiments, and actual implementations may include more or different components arranged in other manners.

System 100 includes analysis server 110 to provide data of data source 120 to analysis client 130. For example, analysis server 110 may receive a manual, ad-hoc or automated, scheduled request for a report from analysis client 130, query data source 120 for data required by the report, receive the data from data source 120, perform any necessarily calculations on the data, format the report including its data, and return the report to analysis client 130.

Data source 120 may comprise any one or more systems to store business data. The data stored in data source 120 may be received from disparate hardware and software systems, some of which are not interoperational with one another. The systems may comprise a back-end data environment employed in a business or industrial context. The data may be pushed to data source 120 and/or provided in response to queries received therefrom.

The data of data source 120 may be stored in traditional fixed disks or in-memory (e.g., in Random Access Memory) to allow fast retrieval and processing thereof. The data may comprise a relational database, an in-memory database, a multi-dimensional database, an eXtendable Markup Language (XML) document, and/or any other structured data storage system. The physical tables of data source 120 may be distributed among several relational databases, multi-dimensional databases, and/or other data sources. To provide economies of scale, data source 120 may include data of more than one customer. In this scenario, analysis server 110 includes mechanisms to ensure that a client accesses only the data that the client is authorized to access. Moreover, the data of data source 120 may be indexed and/or selectively replicated in an index.

Analysis client 130 displays user interfaces and data received from analysis server 110, and may also be operated to process such data and send data back to analysis server 110 for storage in data source 120. Analysis client 130 may comprise any suitable device, such as a desktop computer, a laptop computer, a personal digital assistant, a tablet PC, and a smartphone. Analysis client 130 may execute program code of a spreadsheet application, a spreadsheet application with a plug-in allowing communication (e.g. via Web Services) with analysis server 110, a rich client application (e.g., a Business Intelligence tool), an applet in a Web browser, or any other application to perform the processes attributed thereto herein.

Repository 140 stores metadata and data for use by analysis server 110. The metadata may specify a schema of data source 120, which may be used by analysis server 110 to query data source 120. As will be described below, the metadata may define a portion of a result set defined by a user. Repository 140 may also store the data of one or more instances of the portion. Additionally, in some embodiments, the metadata associated with such a portion may specify a condition, a schedule for evaluating the condition, and a notification type. Generation and use of this metadata according to some embodiments will be described below.

Although system 100 has been described as a distributed system, system 100 may be implemented in some embodiments by a single computing device. For example, both analysis client 130 and analysis server 110 may be embodied by an application executed by a processor of a desktop computer, and data source 120 may be embodied by a fixed disk drive within the desktop computer.

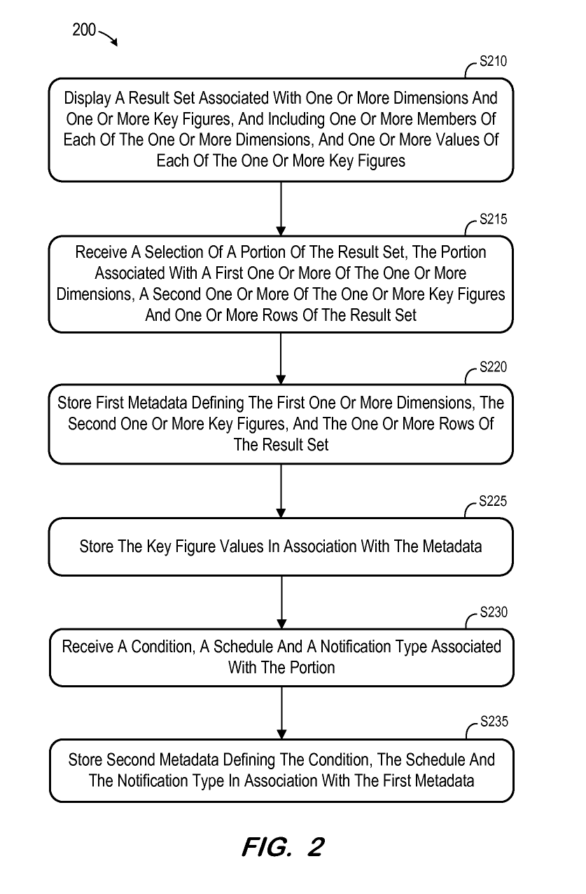

FIG. 2 comprises flow diagram of process 200 according to some embodiments. In some embodiments, various hardware elements of system 100 execute program code to perform process 200. In some embodiments, hard-wired circuitry may be used in place of, or in combination with, program code for implementation of processes according to some embodiments. Embodiments are therefore not limited to any specific combination of hardware and software.

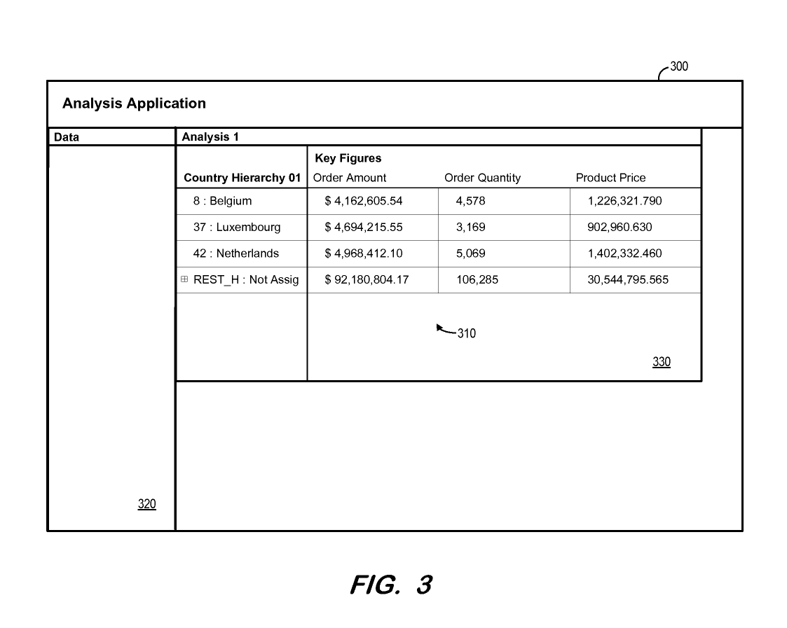

Prior to S210, a user operates analysis client 130 to receive a result set from analysis server 110. To assist in the present description of an example of process 200, FIG. 3 shows a view of user interface 300 according to some embodiments. User interface 300 may be presented on a display of analysis client 130 in response to execution of a Business Intelligence tool by a processor of client 130. Alternatively, user interface 300 may be a Web page displayed by a Web browser application executed by the processor. Embodiments are not limited to these examples.

According to the present example, it will be assumed that a user has manipulated user interface 300 to display result set 310 at S210. Any querying/reporting/analysis paradigm that is or becomes known may be used to retrieve result set 310 according to some embodiments. In some examples, the user drags and drops one or more dimensions, dimension members and key figures from a list within data window 320 into workspace 330. For clarity, such a list is not shown in FIG. 3.

Result set 310 is associated with dimension Country Hierarchy 01 and with key figures Order Amount, Order Quantity and Product Price, but embodiments are not limited to one dimension or to more than one key figure. Result set 310 also includes members of the dimension Country Hierarchy 01 and, for each member, a value for each of the key figures Order Amount, Order Quantity and Product Price.

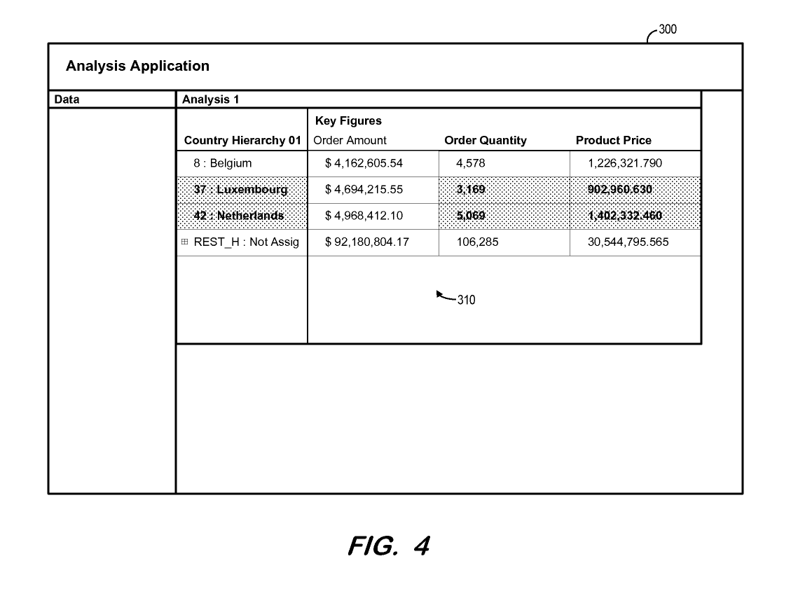

At S215, a selection of a portion of the result set is received. For example, a user may operate a mouse or other input device to select one or more cells of result set 310, and such a selection is received at S215. The selected portion is associated with one or more of the one or more dimensions of the result set, with one or more of the one or more key figures of the result set, and with one or more rows of the result set. FIG. 4 illustrates a selected portion of result set 310 according to some embodiments.

As shown, the columns of the selected portion are associated with dimension Country Hierarchy 01 and with key figures Order Quantity and Product Price. Also noted is that the rows of the selected portion are associated with members 37: Luxembourg and 42: Netherlands of the dimension Country Hierarchy 01. According to some embodiments, a row of the portion may be defined by the one or more dimension members within the row (i.e., row 8: Belgium), or by the vertical position of the row (i.e., first row). The latter definition may be helpful in a case that the user wishes to define the portion so as to include the “top X” rows, regardless of the dimension members which are present within the rows. In this case, the portion is also defined by the sort order in one or more of the key figure columns (i.e., “top X rows based on key figure Y”).

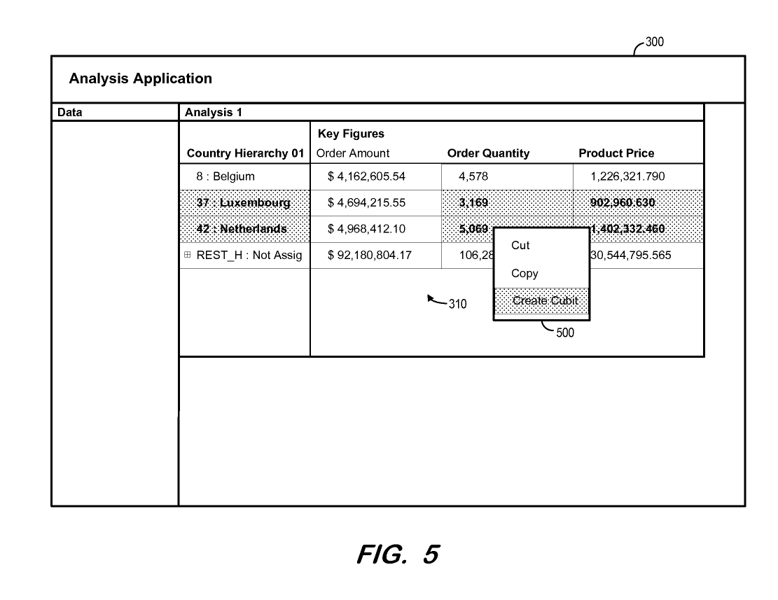

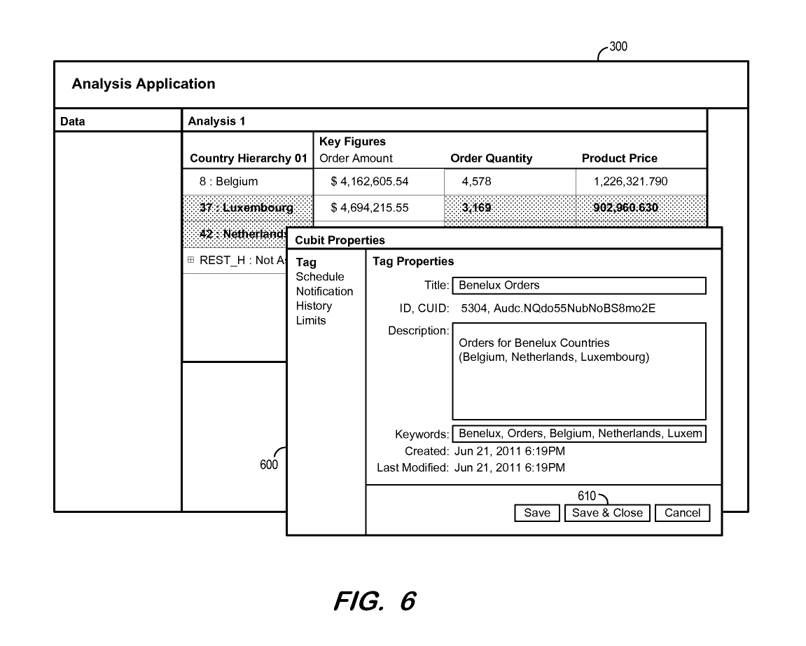

Turning to FIG. 5, the user has right-clicked on one of the selected cells of result set 310 and context menu 500 is displayed in response. The “Create Cubit” option is selected and, as a result, dialog window 600 of FIG. 6 is displayed. Window 600 allows the user to “tag” the selected portion (i.e., the “cubit) with a title, description and keywords.

It will be assumed that the user then selects Save & Close control 610. In response, first metadata defining the selected portion of result set 310 is saved. Specifically, the first metadata defines the one or more selected dimensions of the portion, the selected one or more key figures and the selected one or more rows of the result set. The first metadata may also include the information specified in window 600. According to the present example, analysis server 110 saves the first metadata in repository 140.

The first metadata may conform to any suitable schema or syntax as is known in the art. Again, the first metadata defining the rows of the selected portion may specify the dimension members of the rows and/or the vertical position of the row and the sorting rule which governs the relative positions of the rows within the portion.

According to some embodiments, the key figure values of the selected portion are stored in association with the metadata in repository 140 at S225. These key figure values may be referred to as an “instance” of the portion, while the metadata stored at S220 may be referred to as a “template”.

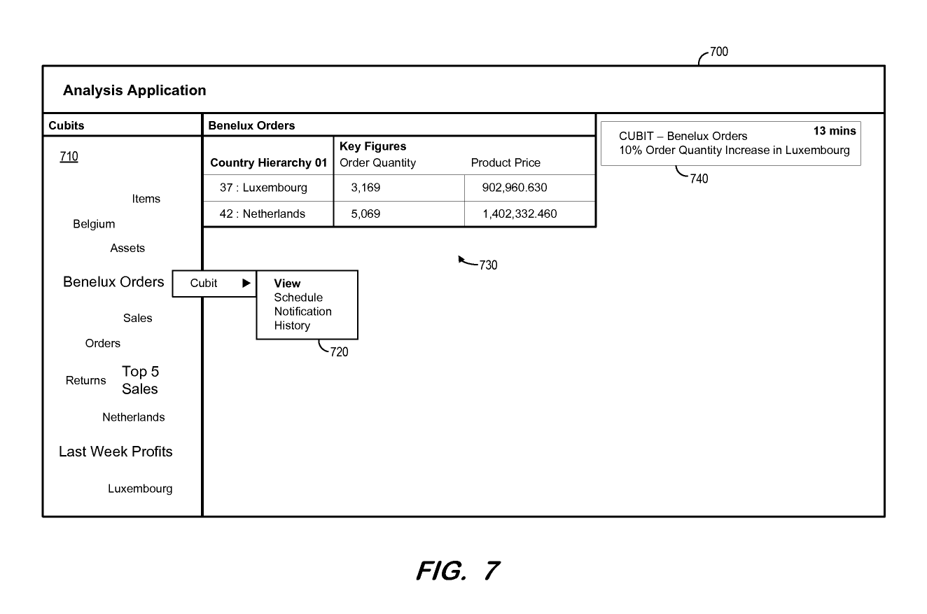

FIG. 7 depicts user interface 700 for managing the saved templates according to some embodiments. Window 710 lists the titles of templates whose metadata is saved in repository 140. The user has selected the “Benelux Orders” template and the function View from resulting context menu 720. Accordingly, saved instance 730 of the Benelux Orders” emplate is displayed. Saved instance 730 reflects the metadata saved at S220 and the key figure values saved at S225. Also displayed is notification 740 related to the template/instance, which will be described in more detail below.

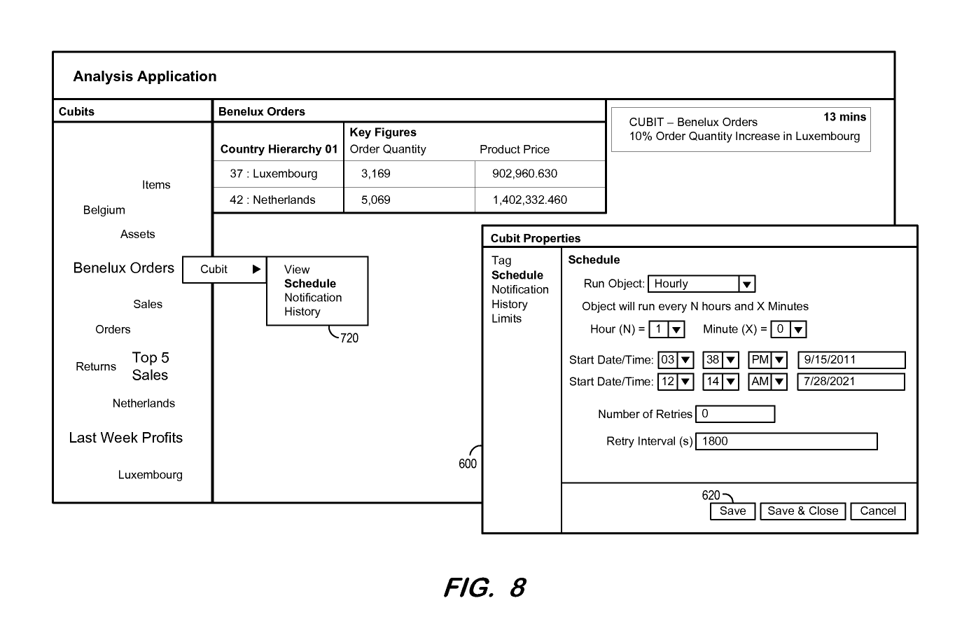

A condition, a schedule, and a notification type associated with the template are received at S230. In one example of S230, FIG. 8 depicts user selection of the Schedule function of context menu 720, which results in display of dialog window 600. The Schedule page of dialog window 600 allows the user to specify a schedule according to which new instances of the template will be generated. These instances may be stored in repository 140 for later access by the user. As will be described below, a generated instance may also be used to evaluate a condition in order to determine whether a notification should be transmitted.

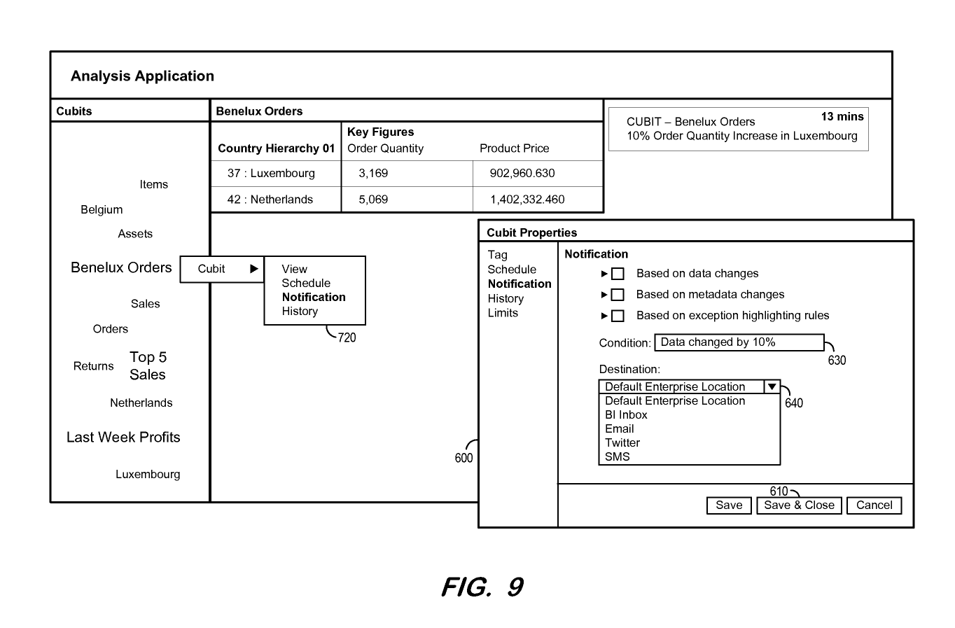

It will be assumed that the user then selects control 620, resulting in reception of the schedule at S230 and display of Notification page of window 600 as shown in FIG. 9. The Notification page allows the user to specify a condition to evaluate based on each instance which is newly-generated according to the specified schedule, and also to specify a type of notification that should be transmitted if the condition evaluates to TRUE.

Specifically, the “based on data changes” condition will evaluate to TRUE if any of the key figure values of a newly-generated instance are different from those of the immediately-prior instance. The “based on metadata changes” condition will evaluate to TRUE if any of the dimension members of a newly-generated instance are different from those of the immediately-prior instance. Lastly, the “based on exception highlighting rules” condition will evaluate to TRUE if the exception noted in condition box 630 is TRUE. According to some embodiments, the user may specify no conditions or more than one condition to associate with a template (i.e., cubit). The user may also specify whether sending a notification requires all or only one of multiple conditions to evaluate to TRUE (i.e., whether the multiple conditions are governed by AND or OR operations).

Drop-down menu 640 allows the user to specify a notification type to send if the condition is TRUE. Embodiments are not limited to the notification types of FIG. 9. According to some embodiments, more than one notification type may be specified for a particular cubit.

The condition(s) and notification type(s) are received at S230 upon user selection of Save & Close control 610. Then, S235, metadata defining the condition, the schedule, and the notification type are saved in association with the template in repository 140.

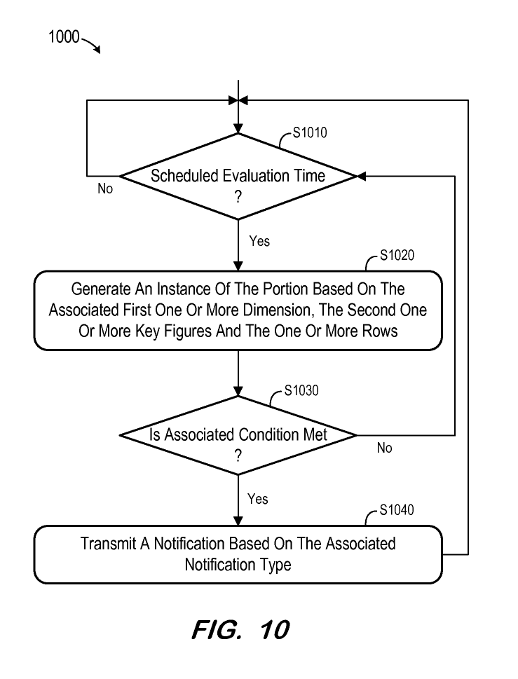

FIG. 10 is a flow diagram of process 1000 to generate template instances according to a schedule as described above, and to evaluate any associated conditions. Process 1000 assumes the existence of metadata defining a condition, a schedule and a notification type. Process 1000 also assumes the existence of an instance and of metadata defining a template of the instance as described above. Such metadata may define one or more dimension members, one or more key figures and one or more rows.

Flow cycles at S1010 until a scheduled evaluation time is reached. In this regard, analysis server 110 may include a scheduling server which tracks all of the schedules defined by metadata in repository 140 and associated with metadata of templates stored in repository 140. Once a scheduled evaluation time associated with a particular template is reached, flow proceeds from S1010 to S1020.

At S1020, an instance of the portion (i.e., template, cubit) is generated based on the metadata defining the portion. Specifically, an instance is generated based on the one or more dimensions, the one or more key figures and the one or more rows specified by the metadata.

If no condition or notification is associated with the template, flow simply returns to S1010 from S1020. Accordingly, repository 140 may maintain a history of instances of the template over time, which may be accessed by a user through analysis client 130.

If an associated condition has been defined, however, the condition is evaluated based on the instance at S1030. As described above, evaluation of the condition may comprise comparing the key figure values and/or dimension members of the instance with key figure values/dimension members of a previously-generated instance of the template. If the condition does not evaluate to TRUE, flow returns to S1010 to await a next scheduled evaluation time.

If the condition evaluates to TRUE, a notification is transmitted at S1040 based on the notification type (or types) associated with the template. The notification may be generated and transmitted at S1040 in any suitable manner that is or becomes known. In some embodiments, the above-mentioned scheduling server includes a notification service to transmit notifications according to their specified type.

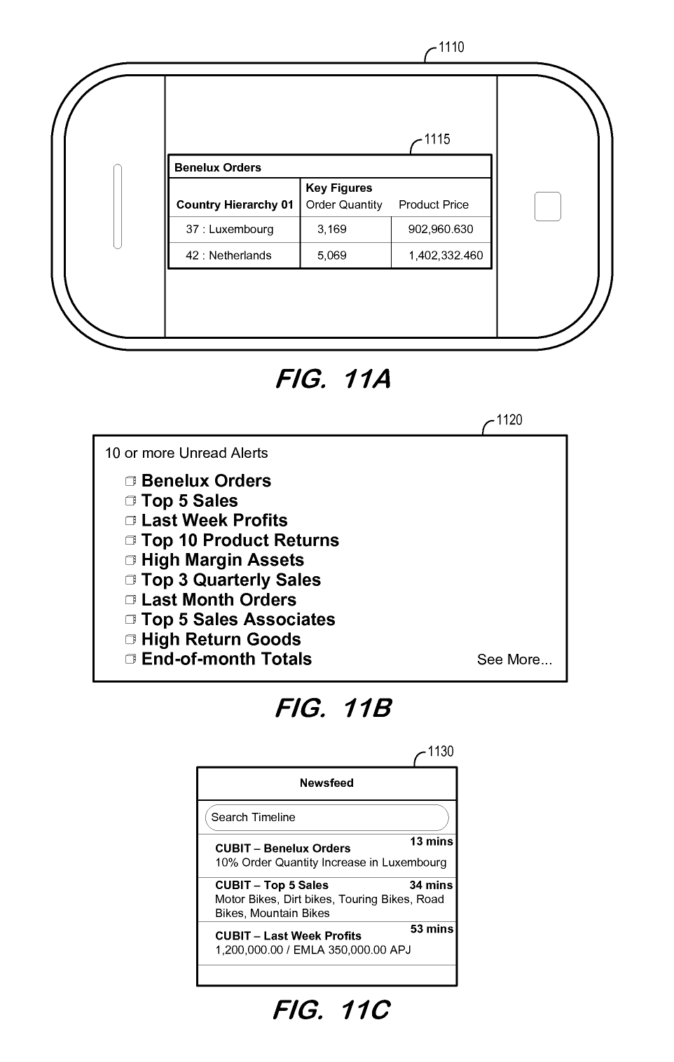

FIGS. 11A through 11C depict several notification types according to some embodiments. FIG. 11A illustrates mobile client device 1110 presenting notification 1115, which was transmitted thereto at S1040. Mobile client device 1110 may, for example, execute a mobile analysis client application to facilitate communication with analysis server 110 and to thereby receive notifications.

FIG. 11B illustrates notifications 1120 formatted as alerts that are presented within an analysis client application user interface, and FIG. 11C illustrates mobile interface 1130 of a newsfeed application (e.g., Twitter) in which notifications are received from analysis server 110 and displayed. Notifications may exhibit any graphical form and/or arrangement suitable to convey their information. In one example, a notification comprises a graph or chart visualization presented on an analytics “dashboard”.

Flow returns to S1010 from S1040 and continues as described above.

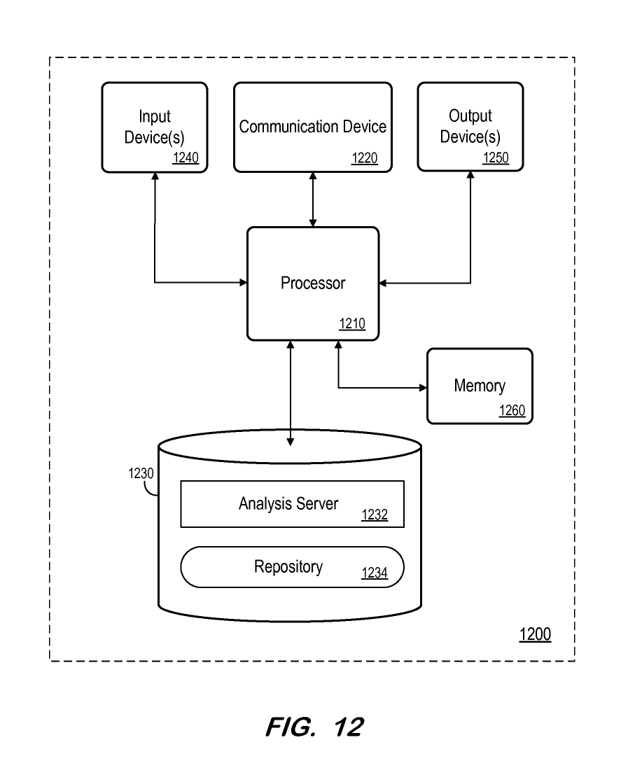

FIG. 12 is a block diagram of apparatus 1200 according to some embodiments. Apparatus 1200 may comprise a general-purpose computing apparatus and may execute program code to perform any of the functions described herein. Apparatus 1200 may comprise an implementation of one or more elements of system 100, such as analysis server 110 and repository 140. Apparatus 1200 may include other unshown elements according to some embodiments.

Apparatus 1200 includes processor 1210 operatively coupled to communication device 1220, data storage device 1230, one or more input devices 1240, one or more output devices 1250 and memory 1260. Communication device 1220 may facilitate communication with external devices, such as an external design tool. Input device(s) 1240 may comprise, for example, a keyboard, a keypad, a mouse or other pointing device, a microphone, knob or a switch, an infra-red (IR) port, a docking station, and/or a touch screen. Input device(s) 1240 may be used, for example, to enter information into apparatus 1200. Output device(s) 1250 may comprise, for example, a display (e.g., a display screen) a speaker, and/or a printer.

Data storage device 1230 may comprise any appropriate persistent storage device, including combinations of magnetic storage devices (e.g., magnetic tape, hard disk drives and flash memory), optical storage devices, Read Only Memory (ROM) devices, etc., while memory 1260 may comprise Random Access Memory (RAM).

Analysis server 1232 of data storage device 1230 may comprise program code executable by processor 1210 to provide any of the functions described herein, including but not limited to process 200 and process 1000. Embodiments are not limited to execution of these functions by a single apparatus. Repository 1234 may store the metadata and instances described herein with respect to repository 140. Memory 1260 may also or alternatively store data of repository 140 and/or data source 120, with data storage device 1230 providing a persistent backup. Data storage device 1230 may also store data and other program code for providing additional functionality and/or which are necessary for operation thereof, such as device drivers, operating system files, etc.

Other topologies may be used in conjunction with other embodiments. Moreover, each system described herein may be implemented by any number of computing devices in communication with one another via any number of other public and/or private networks. Two or more of such computing devices of may be located remote from one another and may communicate with one another via any known manner of network(s) and/or a dedicated connection. Each computing device may comprise any number of hardware and/or software elements suitable to provide the functions described herein as well as any other functions. For example, any computing device used in an implementation of system 100 may include a processor to execute program code such that the computing device operates as described herein.

All systems and processes discussed herein may be embodied in program code stored on one or more computer-readable non-transitory media. Such media non-transitory media may include, for example, a fixed disk, a floppy disk, a CD-ROM, a DVD-ROM, a Flash drive, magnetic tape, and solid state RAM or ROM storage units. Embodiments are therefore not limited to any specific combination of hardware and software.

The embodiments described herein are solely for the purpose of illustration. Those in the art will recognize other embodiments may be practiced with modifications and alterations limited only by the claims.

What is claimed is:

1. A method implemented by a computing system in response to execution of program code by a processor of the computing system, the method comprising:
displaying a result set associated with one or more dimensions and one or more key figures, the result set comprising one or more members of each of the one or more dimensions and one or more values of each of the one or more key figures;
receiving a selection of a portion of the result set, the portion associated with a first one or more of the one or more dimensions, a second one or more of the one or more key figures, and one or more rows of the result set; and
storing metadata defining the first one or more dimensions, the second one or more key figures, and the one or more rows of the result set, and a condition, a schedule to evaluate the condition, and a notification type associated with the portion.

2. A method according to claim 1, the method further comprising:
determining to evaluate the condition based on the schedule;
in response to the determination, generating an instance of the portion based on the first one or more dimensions and the second one or more key figures;
evaluating the condition based on the instance; and
if the condition evaluates as TRUE, transmitting a notification based on the associated notification type.

3. A method according to claim 2, the method further comprising:
prior to determining to evaluate the condition based on the schedule, storing one or more values of each of the one or more key figures,
wherein the instance comprises a second one or more values of each of the one or more key figures, and
wherein evaluating the condition based on the instance comprises determining a difference between the stored one or more values of each of the one or more key figures and the second one or more values of each of the one or more key figures.

4. A method according to claim 2, further comprising:
if the condition evaluates as FALSE, determining to re-evaluate the condition based on the schedule;
in response to the determination to re-evaluate the condition, generating a second instance of the portion based on the first one or more dimensions and the second one or more key figures;
evaluating the condition based on the second instance; and
if the condition evaluates as TRUE based on the second instance, transmitting a notification based on the associated notification type.

5. A method according to claim 4, the method further comprising:
prior to determining to evaluate the condition based on the schedule, storing one or more values of each of the one or more key figures,
wherein the instance comprises a second one or more values of each of the one or more key figures, and
wherein evaluating the condition based on the instance comprises determining a difference between the stored one or more values of each of the one or more key figures and the second one or more values of each of the one or more key figures.

6. A method according to claim 1, further comprising:
receiving the result set from a multi-dimensional data provider.

7. A non-transitory medium storing processor-executable program code, the program code executable by a processor of a computing device to:
display a result set associated with one or more dimensions and one or more key figures, the result set comprising one or more members of each of the one or more dimensions and one or more values of each of the one or more key figures;
receive a selection of a portion of the result set, the portion associated with a first one or more of the one or more dimensions, a second one or more of the one or more key figures, and one or more rows of the result set; and
store metadata defining the first one or more dimensions, the second one or more key figures, and the one or more rows of the result set, and a condition, a schedule to evaluate the condition, and a notification type associated with the portion.

8. A medium according to claim 7, the program code further executable by a processor of a computing device to:
determine to evaluate the condition based on the schedule;
in response to the determination, generate an instance of the portion based on the first one or more dimensions and the second one or more key figures;
evaluate the condition based on the instance; and
if the condition evaluates as TRUE, transmit a notification based on the associated notification type.

9. A medium according to claim 8, the program code further executable by a processor of a computing device to:
prior to the determination to evaluate the condition based on the schedule, store one or more values of each of the one or more key figures,
wherein the instance comprises a second one or more values of each of the one or more key figures, and
wherein evaluation of the condition based on the instance comprises determination of a difference between the stored one or more values of each of the one or more key figures and the second one or more values of each of the one or more key figures.

10. A medium according to claim 8, the program code further executable by a processor of a computing device to:
if the condition evaluates as FALSE, determine to re-evaluate the condition based on the schedule;
in response to the determination to re-evaluate the condition, generate a second instance of the portion based on the first one or more dimensions and the second one or more key figures;
evaluate the condition based on the second instance; and
if the condition evaluates as TRUE based on the second instance, transmit a notification based on the associated notification type.

11. A medium according to claim 10, the program code further executable by a processor of a computing device to:
prior to the determination to evaluate the condition based on the schedule, store one or more values of each of the one or more key figures,
wherein the instance comprises a second one or more values of each of the one or more key figures, and
wherein evaluation of the condition based on the instance comprises determination of a difference between the stored one or more values of each of the one or more key figures and the second one or more values of each of the one or more key figures.

12. A medium according to claim 7, the program code further executable by a processor of a computing device to:
receive the result set from a multi-dimensional data provider.

13. A system comprising:
a computing device comprising:
a memory storing processor-executable program code; and
a processor to execute the processor-executable program code in order to cause the computing device to:
display a result set associated with one or more dimensions and one or more key figures, the result set comprising one or more members of each of the one or more dimensions and one or more values of each of the one or more key figures;
receive a selection of a portion of the result set, the portion associated with a first one or more of the one or more dimensions, a second one or more of the one or more key figures, and one or more rows of the result set; and
store metadata defining the first one or more dimensions, the second one or more key figures, and the one or more rows of the result set, and a condition, a schedule to evaluate the condition, and a notification type associated with the portion.

14. A system according to claim 13, the program code further executable by a processor of a computing device to:
determine to evaluate the condition based on the schedule;
in response to the determination, generate an instance of the portion based on the first one or more dimensions and the second one or more key figures;
evaluate the condition based on the instance; and
if the condition evaluates as TRUE, transmit a notification based on the associated notification type.

15. A system according to claim 14, the processor further to execute the processor-executable program code in order to cause the computing device to:
prior to the determination to evaluate the condition based on the schedule, store one or more values of each of the one or more key figures,
wherein the instance comprises a second one or more values of each of the one or more key figures, and
wherein evaluation of the condition based on the instance comprises determination of a difference between the stored one or more values of each of the one or more key figures and the second one or more values of each of the one or more key figures.

16. A system according to claim 14, the processor further to execute the processor-executable program code in order to cause the computing device to:
if the condition evaluates as FALSE, determine to re-evaluate the condition based on the schedule;
in response to the determination to re-evaluate the condition, generate a second instance of the portion based on the first one or more dimensions and the second one or more key figures;
evaluate the condition based on the second instance; and
if the condition evaluates as TRUE based on the second instance, transmit a notification based on the associated notification type.

17. A system according to claim 16, the processor further to execute the processor-executable program code in order to cause the computing device to:
prior to the determination to evaluate the condition based on the schedule, store one or more values of each of the one or more key figures,
wherein the instance comprises a second one or more values of each of the one or more key figures, and
wherein evaluation of the condition based on the instance comprises determination of a difference between the stored one or more values of each of the one or more key figures and the second one or more values of each of the one or more key figures.

18. A system according to claim 13, the processor further to execute the processor-executable program code in order to cause the computing device to:
receive the result set from a multi-dimensional data provider.
